(19) United States
(12) Patent Application Publication
(10) Pub. No.: US 2025/0261277 A1
(43) Pub. Date: Aug. 14, 2025

(54) Scaling Factor in RRC_IDLE for FR2-2

(71) Applicant: Apple Inc., CUPERTINO, CA (US)

(72) Inventors: Xiang CHEN, Campbell, CA (US); Dawei ZHANG, Saratoga, CA (US); Huaning NIU, San Jose, CA (US); Jie CUI, San Jose, CA (US); Manasa RAGHAVAN, Sunnyvale, CA (US); Qiming Li, Beijing (CN); Yang TANG, San Jose, CA (US)

(21) Appl. No.: 18/857,268

(22) PCT Filed: Apr. 24, 2022
(86) PCT No.: PCT/CN2022/088813

§ 371 Date: Oct. 16, 2024

(51) Int. Cl. H04W 76/28; H04B 7/06; H04W 8/22; H04W 24/10

(52) U.S. Cl. CPC H04W 76/28; H04B 7/06952; H04W 8/22; H04W 24/10

(57) ABSTRACT

A user equipment (UE) is configured to receive a configuration from a base station of a network for operations on frequency range FR2-2, the configuration including a parameter for a discontinuous reception (DRX) cycle duration, determine, based on the configuration, a value from a set of beam sweeping scaling factors used for operations on FR2-2 different from the beam sweeping scaling factors used for operations on frequency ranges FR1 or FR2-1, determine an evaluation period for performing cell measurement and evaluation based on the value of the scaling factor and the DRX cycle duration and perform the cell measurement and evaluation for at least the evaluation period while in a radio resource control (RRC) idle state.

### TECHNICAL FIELD

The present disclosure generally relates to communication, and in particular, to the scaling factor in RRC IDLE for FR2-2.

### BACKGROUND

A user equipment (UE) may be configured to establish a connection with a network, e.g., a 5G New Radio (NR) network. NR specifications have been developed defining operations for frequencies up to 52.6 GHZ, e.g., in frequency ranges FR1 and FR2-1, where all physical layer channels, signals, procedures, and protocols are designed to be optimized for uses under 52.6 GHz. Specifications defining operations for frequencies over 52.6 GHZ, e.g., in frequency range FR2-2, are in development, however, various challenges arise when using these higher frequencies relative to those under 52.6 GHZ. For example, higher frequencies experience higher phase noise, higher pathloss, and lower power amplifier efficiency.

To mitigate the problem of higher pathloss, the number of antenna elements per panel for UEs designed to operate in FR2-2 may be increased from four antenna elements to eight antenna elements to increase the beamforming gain of transmissions to/from the network. However, according to current specifications, the UE may be unable to properly conduct serving cell measurements and evaluations (or intra-frequency/inter-frequency cell measurements/evaluations) when the UE is receiving the narrower beam during gNB beam sweeps.

### SUMMARY

Some exemplary embodiments are related to a processor of a user equipment (UE) configured to perform operations. The operations include receiving a configuration from a base station of a network for operations on frequency range FR2-2, the configuration including a parameter for a discontinuous reception (DRX) cycle duration, determining, based on the configuration, a value from a set of beam sweeping scaling factors used for operations on FR2-2 different from the beam sweeping scaling factors used for operations on frequency ranges FR1 or FR2-1, determining an evaluation period for performing cell measurement and evaluation based on the value of the scaling factor and the DRX cycle duration and performing the cell measurement and evaluation for at least the evaluation period while in a radio resource control (RRC) idle state.

Other exemplary embodiments are related to a processor of a user equipment (UE) configured to perform operations. The operations include receiving a configuration from a base station of a network for operations on frequency range FR2-2, the configuration including a parameter for a discontinuous reception (DRX) cycle duration and a parameter indicating an upper limit for an evaluation period for performing cell measurement and evaluation and performing the cell measurement and evaluation for at least the evaluation period while in a radio resource control (RRC) idle state.

Still further exemplary embodiments are related to a processor of a base station configured to perform operations. The operations include transmitting a configuration to a user equipment (UE) for operations on frequency range FR2-2, the configuration including a parameter for a discontinuous reception (DRX) cycle duration and a parameter indicating an upper limit for an evaluation period for performing cell measurement and evaluation and transmitting reference signals (RS) for measurement and evaluation by the UE in accordance with the configuration for the UE.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an example of four antenna modules and their corresponding radiation patterns.

FIG. 5 shows a table for determining the evaluation period Nₛₑᵣᵥ DRX cycles.

FIG. 6 shows an exemplary table for determining the evaluation period Nₛₑᵣᵥ DRX cycles for FR2-2 operations according to various exemplary embodiments.

FIG. 7 shows a method for serving cell measurement and evaluation according to various exemplary embodiments.

### DETAILED DESCRIPTION

The exemplary embodiments may be further understood with reference to the following description and the related appended drawings, wherein like elements are provided with the same reference numerals. The exemplary embodiments describe operations for performing serving cell measurement and evaluation. Specifically, the exemplary embodiments describe a design for the receiving (Rx) beam sweeping scaling factor for operations in frequency range FR2-2, where the design is based on various user equipment (UE) and radio access network (RAN) considerations including, for example, a change in UE hardware capabilities. For UEs designed for operation in the FR2-2 frequency range, the number of antenna elements per panel can be increased from four to eight antenna elements. Operations on FR2-2 can be specified in consideration of the reduced beam width resulting from the use of eight antenna elements per panel.

The exemplary embodiments are described with regard to a user equipment (UE). Those skilled in the art will understand that the UE may be any type of electronic component that is configured to communicate via a network, e.g., mobile phones, tablet computers, desktop computers, smartphones, phablets, embedded devices, wearables, Internet of Things (IoT) devices, etc. Therefore, the UE as described herein is used to represent any electronic component that directly communicates with the network.

The exemplary embodiments are also described with regard to a 5G New Radio (NR) network. However, reference to a 5G NR network is merely provided for illustrative purposes. The exemplary embodiments may be utilized with any network implementing mobility measurement methodologies similar to those described herein. Therefore, the 5G NR network as described herein may represent any type of network implementing similar mobility measurement functionalities as the 5G NR network.

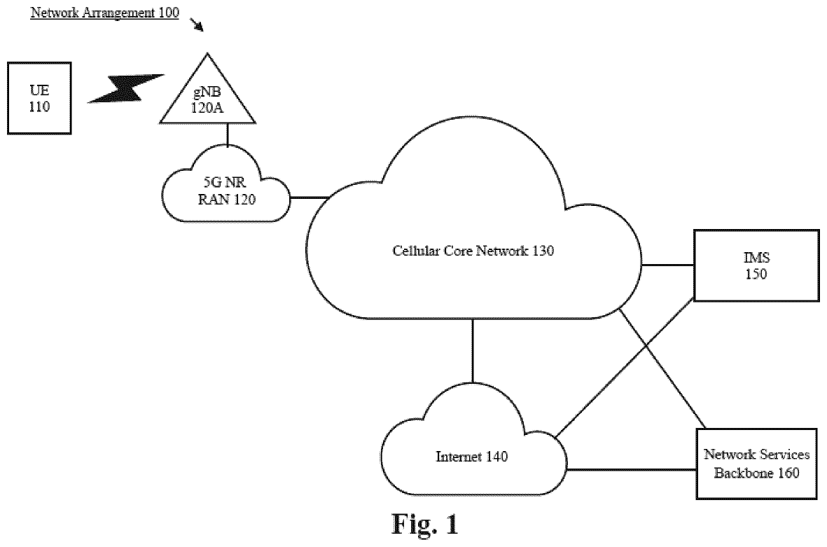

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., HMD, AR glasses, etc.), Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

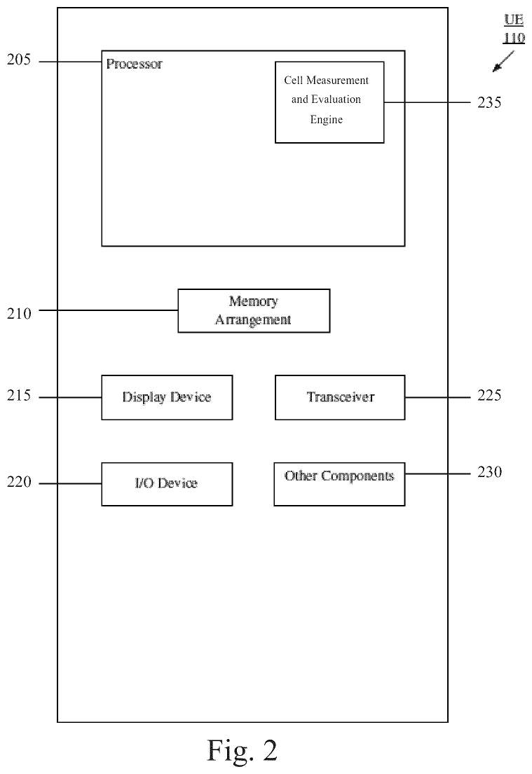

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a cell measurement and evaluation engine 235 for performing operations including receiving a configuration for operations on frequency range FR2-2, determining an evaluation period to use for serving cell measurement/evaluation (and/or other idle mode requirements such as intra-frequency/inter-frequency measurement/evaluation) according to the configured parameters, and performing the serving cell measurement/evaluation in accordance with the determined evaluation period. When the cell selection criterion S is not satisfied for Nₛₑᵣᵥ consecutive cycles, the UE can initiate neighbor cell and/or intra-frequency or inter-frequency measurements to find a suitable cell to camp on.

The above referenced engine 235 being an application (e.g., a program) executed by the processor 205 is provided merely for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

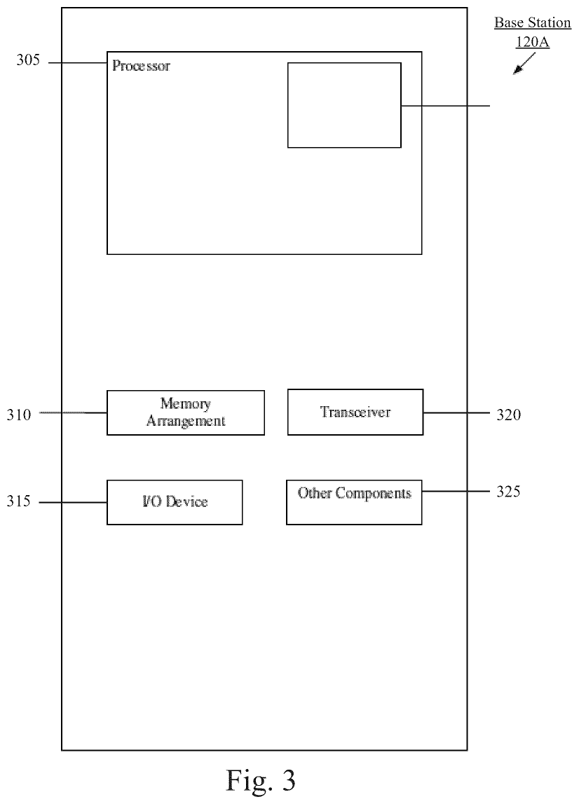

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc. The functionality associated with the processor may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

Beamforming refers to an antenna technique that can be used to propagate a directional signal over a mmWave frequency band. Throughout this description, the term “beam” may refer to a beamformed signal. However, reference to a beam is merely exemplary. Different networks may refer to a signal propagated over mmWave frequencies by a different name. To generate a beam, a plurality of antenna elements may be configured to radiate the same signal. Increasing the number of antenna elements radiating the signal decreases the width of the radiation pattern and increases the gain.

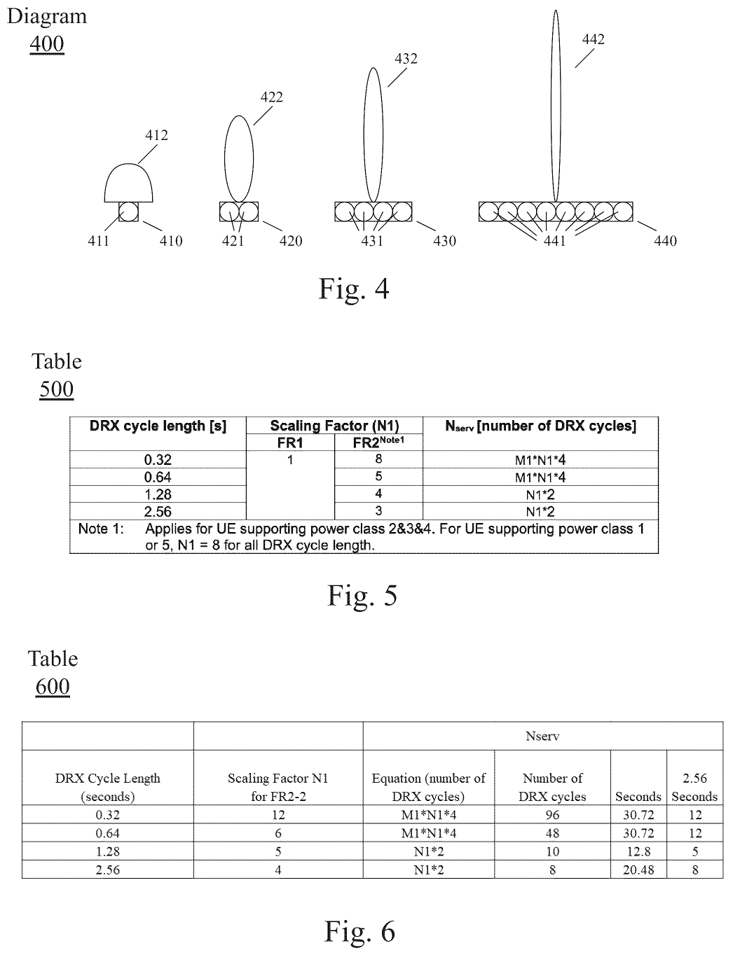

FIG. 4 shows an example of four antenna modules 410, 420, 430, 440 and their corresponding radiation patterns 412, 422, 432, 442. Antenna module 410 includes a single antenna element 411 and generates the radiation pattern 412. Antenna module 420 includes two antenna elements 421 and generates the radiation pattern 422. Antenna module 430 includes four antenna elements 431 and generates the radiation pattern 432. Antenna module 440 includes four antenna elements 441 and generates the radiation pattern 442. A comparison of the radiation patterns 412, 422, 432, 442 illustrates the effects the number of antenna elements has on the geometry of the radiation pattern. For instance, in this example, the radiation pattern 412 is the widest radiation pattern because the antenna module 410 has the fewest number of antenna elements (e.g., one). The antenna module 420 has two antenna elements 421. The additional antenna element allows antenna module 420 to generate a radiation pattern 422 that is narrower than the radiation pattern 412. The antenna module 430 has four antenna elements 431. The additional antenna elements allows antenna module 430 to generate a radiation pattern 432 that is narrower than the radiation pattern 422. The antenna module 440 has eight antenna elements 441. The additional antenna elements allows antenna module 440 to generate a radiation pattern 442 that is narrower than the radiation patterns 432. Thus, compared to antenna modules 410, 420, 430, antenna module 440 has the most antenna elements. As a result, the antenna module 440 is able to generate a radiation pattern 442 that is narrower than the radiation patterns 412, 422, 432, and provides the most gain. It should be understood that the size of the beams 412, 422, 432, 442 illustrated in FIG. 4 is provided for illustrative purposes only to show the narrowing of the beam generated using an increasing number of antenna elements per panel.

A base station, e.g., the gNB 120A described above, may perform one or more transmitter (Tx) beam sweeps as part of RRC connection establishment for a UE, e.g., the UE 110, in the RRC IDLE state. The transmitter beam sweep refers to transmitting a plurality of transmitter beams over a particular spatial area during a predetermined duration. Each beam transmitted during a transmitter beam sweep may include one or more reference signals. The UE 110 can measure the transmitter beams (e.g., receiver (Rx) beam sweep) based on the respective reference signals.

The Synchronization signal block (SSB) radio resource management (RRM) Measurement Timing Configuration window, referred to as the SMTC window, relates to the measurement periodicity and timing of SSBs that the UE can use for cell measurements. The SMTC window periodicity can correspond to the periodicity of the SSBs (e.g. {5, 10, 20, 40, 80, 160} ms) and the window duration can be set to {1, 2, 3, 4, 5} ms, according to the number of SSBs transmitted on the cell being measured.

For the UE in the RRC IDLE state, minimum requirements are specified in TS 38.133 clause 4.2.2.2 for the measurement and evaluation of serving cells. To measure and evaluate a serving cell, the UE measures the synchronization signal (SS) reference signal received power (SS-RSRP) and SS reference signal received quality (SS-RSRQ) level of the serving cell and evaluates cell selection criterion S at least once every M1*N1 DRX cycle, where M1=2 if the SMTC periodicity is greater than 20 ms and the DRX cycle is less than 0.64 seconds, otherwise, M1=1; and N1 refers to the beam sweeping scaling factor, to be described in greater detail below. Those skilled in the art will understand that the UE 110 may be configured with a DRX cycle to conserve power at the UE 110 during a sleep portion of the DRX cycle. The DRX cycle generally comprises one from the set of {0.32, 0.64, 1.28, 2.56} seconds.

If the UE has evaluated in Nₛₑᵣᵥ consecutive DRX cycles that the serving cell does not fulfil the cell selection criterion S, the UE initiates neighbor cell measurements to find a suitable cell to camp on. The value of Nₛₑᵣᵥ depends on factors such as: DRX cycle length, power class, frequency range (FR1 or FR2), scaling factor (N1), and SMTC periodicity (e.g., M1=1 or 2), as shown in FIG. 5.

FIG. 5 shows a table 500 for determining the evaluation period Nₛₑᵣᵥ DRX cycles. As shown, the scaling factor N1 can vary depending on frequency range and DRX cycle length (in FR2), and the equation used to calculate Nₛₑᵣᵥ can vary depending on the DRX cycle length. As described above, the M1 value of 2 is used to calculate Nₛₑᵣᵥ only for SMTC periodicities >20 and DRX cycles <0.64 seconds. Additionally, the N1 values shown in the table 500 for FR2 are applicable for power classes 2, 3, and 4, wherein N1=8 for power classes 1 and 5.

Those skilled in the art will understand that the term “FR2” shown in the table 400 may be referred to as “FR2-1” and corresponds to frequencies allocated to the mmWave region and includes frequency ranges from 24.25 GHZ to 52.6 GHz. The term “FR2-2” may refer to frequencies over 52.6 GHZ, e.g., frequency ranges from 52.6 GHz to 71 GHz, and may include licensed or unlicensed bands. Similarly, FR1 may refer to sub-6 GHZ frequency bands allocated to 5G networks.

Specifications defining operations for frequencies over 52.6 GHZ, e.g., in frequency range FR2-2, are in development, however, various challenges arise when using these higher frequencies relative to those under 52.6 GHZ. For example, higher frequencies experience higher phase noise, higher pathloss, and lower power amplifier efficiency.

To mitigate the problem of higher pathloss, the number of antenna elements for UEs designed to operate in FR2-2 may be increased from four antennas to eight antennas to increase the beamforming gain of transmissions to/from the network. However, the UE may need more time to properly conduct serving cell measurement and evaluation when the UE is receiving the narrower beam during Rx beam sweeps. For example, the UE may require a longer serving cell measurement and evaluation period, relative to current specification for FR2-1, to ensure mobility performance for operations on FR2-2 using the increased number of antenna elements.

According to various exemplary embodiments described herein, for UEs in the RRC IDLE state, the Rx beam sweeping scaling factor is considered together with the length of DRX cycles and SMTC periodicity to ensure UE power consumption and mobility performance for operations on FR2-2.

According to various exemplary embodiments described herein, an upper bound is set for the UE measurement and evaluation period of a serving cell. From this upper bound, and in consideration of additional factors, the scaling factors N1 for different DRX cycles can be determined for FR2-2 operations. It is noted that these embodiments are primarily described relative to serving cell measurements, however, the scaling factor design can also be applied for other IDLE mode requirements such as intra-frequency/inter-frequency measurements (e.g., of neighbor cells).

According to one option, the scaling factor N1 can be pre-defined in specification, wherein the N1 values are selected so that the UE mobility performance can be ensured. A table similar to the table 500 shown in FIG. 5 can be specified so that respective sets of scaling factors can be applied for serving cell measurement/evaluation operations FR2-2 as well as in FR1 and FR2-1. When the UE is configured for operations on FR2-2, the UE can apply a value from a set of scaling factors different from the scaling factors that are used for operations on FR1 or FR2-1.

The scaling factor values for each of the DRX cycles can be selected so that the serving cell measurement and evaluation period is within a pre-defined upper limit, expressed in seconds and/or units comprising 2.56 s (e.g., X*2.56 s). For FR2-2 operations, the upper limit and associated scaling factors can be increased relative to the FR2-1 operations.

Referring to table 500 in FIG. 5 above, in FR2 (FR2-1), the upper limit for the serving cell measurement and evaluation period corresponds to the scenario where a DRX cycle of 0.64 is configured and the SMTC window is greater than 20 ms (e.g., M1=2). In this scenario, Nₛₑᵣᵥ=2*5*4=40 DRX cycles, which, for the DRX cycle of 0.64, corresponds to 10*2.56 s. This duration corresponds to the upper limit for the serving cell measurement and evaluation period. To provide another example, where a DRX cycle of 0.32 is configured and M1=2, Nₛₑᵣᵥ=2*8*4=64 DRX cycles, which, for the DRX cycle of 0.32, corresponds to 8*2.56 s.

For FR2-2, the upper limit and associated scaling factors can be increased relative to the FR2-1 operations. The upper bound can be established based on any DRX cycle, M1, and scaling factor N1 value. For example, for a DRX cycle of 0.32 s and M1=2, the scaling factor N1 can be selected as 12. In this scenario, Nₛₑᵣᵥ=2*12*4=96 DRX cycles, which, for the DRX cycle of 0.32, corresponds to 12*2.56 s.

FIG. 6 shows an exemplary table 600 for determining the evaluation period Nₛₑᵣᵥ DRX cycles for FR2-2 operations according to various exemplary embodiments. As shown, N1=12 for DRX=0.32; N1=6 for DRX=0.64; N1=5 for DRX=1.28; N1=4 for DRX=2.56. These values can be selected to balance the various considerations of the UE, e.g., power consumption, mobility performance, etc., while staying below the upper limit for the serving cell evaluation period, which in this example equals 12*2.56 s.

It should be understood by those skilled in the art that other values can be selected for the serving cell evaluation period, e.g., >12*2.56 s, and the parameters influencing the evaluation period Nₛₑᵣᵥ can also be selected differently, including the scaling factor N1 values and additionally the M1 value(s) and/or the equation(s) used to calculate Nₛₑᵣᵥ for the various DRX cycles. Thus, the values shown in the table 600 of FIG. 6 are used only for illustrative purposes.

It should be understood that the Nₛₑᵣᵥ values can be calculated by the UE and are included in the table for illustrative purposes only, e.g., they need not be included in specification.

According to another option, the upper bound for the serving cell evaluation period, as described above, can be configured by the network. For example, the network can select a value of 12*2.56 s as the upper limit and broadcast the value as a parameter in, e.g., system information block 1 (SIB1). When the UE decodes the value, the UE can apply it to the different DRX cycle lengths according to UE implementation. In some embodiments, the N1 value may not be predefined in specification and can be left to UE implementation. The scaling factor N1 can be determined from this upper limit configured by the network.

Once defined by either specification or based on the network configuration, the N1 values as described herein can be applied to other idle mode measurement requirements, including, e.g., measurement of intra-frequency NR cells or measurements of inter-frequency NR cells. In addition, the exemplary embodiments described herein can be applied to all UE power classes.

In some embodiments, both options for determining N1 (e.g., defined in specification and network-configured) can be specified to accommodate different UE implementations or capabilities. If both options are used, a UE capability can be defined to indicate either or both options.

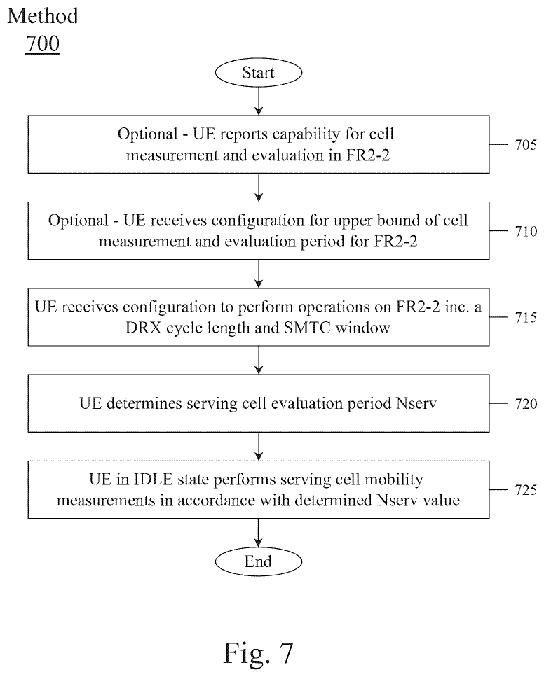

FIG. 7 shows a method 700 for serving cell measurement and evaluation according to various exemplary embodiments. As described above, the UE as described herein can be capable of operations in the FR2-2 frequency range and may, in some scenarios, comprise eight antenna elements used for Tx and Rx beamforming.

In optional 705, the UE reports one or more capabilities to the network for cell measurement and evaluation in FR2-2. As described above, the beam sweeping scaling factors N1 for the different DRX cycles can be pre-defined in specification or can be configured by the network, and, if both options are specified, the UE can report its support or either one or both of the options. The capability can be applied for serving cell measurements/evaluation and/or neighbor cell and/or intra-frequency or inter-frequency measurements/evaluation.

In optional 710, if the network-configuration option is used, the UE receives a configuration for the upper bound of the serving cell measurement and evaluation period for FR2-2. Alternatively, the UE may have this value defined in specification.

In 715, the UE receives a configuration to perform operations on FR2-2, the configuration including, e.g., a DRX cycle length, a SMTC window, etc.

In 720, the UE determines a serving cell evaluation period Nₛₑᵣᵥ. In one option, Nₛₑᵣᵥ is determined from specification and is based on the configured DRX cycle and the SMTC window duration. In another option, Nₛₑᵣᵥ is determined from the network configuration of the upper limit for the evaluation period. The UE may determine Nₛₑᵣᵥ when the UE enters the IDLE state

In 725, the UE performs the serving cell mobility measurements in the IDLE state in accordance with the determined serving cell evaluation period Nₛₑᵣᵥ. If the cell selection criterion S is not satisfied for Nₛₑᵣᵥ Consecutive DRX cycles, the UE can initiate other idle mode requirements including, e.g., neighbor cell measurements and/or intra-frequency and/or inter-frequency measurements. The N1 value used for the serving cell measurements can also be used for the other idle mode requirements, as described above.

### EXAMPLES

In a first example, a method performed by a user equipment (UE) comprising receiving a configuration from a base station of a network for operations on frequency range FR2-2, the configuration including a parameter for a discontinuous reception (DRX) cycle duration, determining, based on the configuration, a value from a set of beam sweeping scaling factors used for operations on FR2-2 different from the beam sweeping scaling factors used for operations on frequency ranges FR1 or FR2-1, determining an evaluation period for performing cell measurement and evaluation based on the value of the scaling factor and the DRX cycle duration and performing the cell measurement and evaluation for at least the evaluation period while in a radio resource control (RRC) idle state.

In a second example, the method of the first example, wherein the cell comprises a serving cell, and when a cell selection criterion S is not satisfied for an entirety of the evaluation period, performing neighbor cell measurement and evaluation to find a suitable cell.

In a third example, the method of the first example, wherein the UE comprises eight antenna elements per panel for performing the operations on FR2-2.

In a fourth example, the method of the first example, wherein the set of beam sweeping scaling factors for FR2-2 comprises values greater than values from a set of beam sweeping scaling factors for FR2-1.

In a fifth example, the method of the first example, wherein the set of beam sweeping scaling factors for FR2-2 are applied for all power classes.

In a sixth example, the method of the fifth example, wherein the set of beam sweeping scaling factors for FR2-2 comprises an N1 value for each of a plurality of DRX cycles.

In a seventh example, the method of the first example, further comprising reporting a capability to the network for using the set of beam sweeping scaling factors for FR2-2.

In an eighth example, the method of the first example, wherein the cell comprises a neighbor cell and the cell measurement and evaluation is intra-frequency measurements or inter-frequency measurements.

In a ninth example, a user equipment (UE) comprises a transceiver configured to communicate with a base station of a network and a processor communicatively coupled to the transceiver and configured to perform any of the methods of the first through eighth examples.

In a tenth example, a method performed by a user equipment (UE), comprising receiving a configuration from a base station of a network for operations on frequency range FR2-2, the configuration including a parameter for a discontinuous reception (DRX) cycle duration and a parameter indicating an upper limit for an evaluation period for performing cell measurement and evaluation and performing the cell measurement and evaluation for at least the evaluation period while in a radio resource control (RRC) idle state.

In an eleventh example, the method of the tenth example, wherein the cell comprises a serving cell, and when a cell selection criterion S is not satisfied for an entirety of the evaluation period, performing neighbor cell measurement and evaluation to find a suitable cell.

In a twelfth example, the method of the tenth example, further comprising determining, from the configuration, a value of a beam sweeping scaling factor to use for the operations on FR2-2 based on the DRX cycle and the upper limit for the evaluation period and using the determined scaling factor value for other RRC idle operations.

In a thirteenth example, the method of the tenth example, wherein the UE comprises eight antenna elements per panel for performing the operations on FR2-2.

In a fourteenth example, the method of the tenth example, further comprising reporting a capability to the network for receiving the configuration for the upper limit for the evaluation period for performing serving cell measurement and evaluation for FR2-2.

In a fifteenth example, the method of the tenth example, wherein the cell comprises a neighbor cell and the cell measurement and evaluation is intra-frequency measurements or inter-frequency measurements.

In a sixteenth example, a user equipment (UE) comprises a transceiver configured to communicate with a base station of a network and a processor communicatively coupled to the transceiver and configured to perform any of the methods of the tenth through fifteenth examples.

In a seventeenth example, a method performed by a base station, comprising transmitting a configuration to a user equipment (UE) for operations on frequency range FR2-2, the configuration including a parameter for a discontinuous reception (DRX) cycle duration and a parameter indicating an upper limit for an evaluation period for performing cell measurement and evaluation and transmitting reference signals (RS) for measurement and evaluation by the UE in accordance with the configuration for the UE.

In an eighteenth example, the method of the seventeenth example, wherein the UE comprises eight antenna elements per panel for performing the operations on FR2-2.

In an nineteenth example, the method of the seventeenth example, further comprising receiving a capability report from the UE for receiving the configuration for the upper limit for the evaluation period for performing serving cell measurement and evaluation for FR2-2.

In a twentieth example, the method of the seventeenth example, wherein the cell comprises a serving cell.

In a twenty first example, the method of the seventeenth example, wherein the cell comprises a neighbor cell and the cell measurement and evaluation is intra-frequency measurements or inter-frequency measurements.

In a twenty third example, a base station comprises a transceiver configured to communicate with a user equipment (UE) and a processor communicatively coupled to the transceiver and configured to perform any of the methods of the seventeenth through twenty first examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured to perform operations comprising:
receiving a configuration from a base station of a network for operations on frequency range FR2-2, the configuration including a parameter for a discontinuous reception (DRX) cycle duration;
determining, based on the configuration, a value from a set of beam sweeping scaling factors used for operations on FR2-2 different from the beam sweeping scaling factors used for operations on frequency ranges FR1 or FR2-1;
determining an evaluation period for performing cell measurement and evaluation based on the value of the scaling factor and the DRX cycle duration; and
performing the cell measurement and evaluation for at least the evaluation period while in a radio resource control (RRC) idle state.

2. The processor of claim 1, wherein the cell comprises a serving cell, and
when a cell selection criterion S is not satisfied for an entirety of the evaluation period, performing neighbor cell measurement and evaluation to find a suitable cell.

3. The processor of claim 1, wherein the UE comprises eight antenna elements per panel for performing the operations on FR2-2.

4. The processor of claim 1, wherein the set of beam sweeping scaling factors for FR2-2 comprises values greater than values from a set of beam sweeping scaling factors for FR2-1.

5. The processor of claim 1, wherein the set of beam sweeping scaling factors for FR2-2 are applied for all power classes.

6. The processor of claim 4, wherein the set of beam sweeping scaling factors for FR2-2 comprises an N1 value for each of a plurality of DRX cycles.

7. The processor of claim 1, wherein the operations further comprise:
reporting a capability to the network for using the set of beam sweeping scaling factors for FR2-2.

8. The processor of claim 1, wherein the cell comprises a neighbor cell and the cell measurement and evaluation is intra-frequency measurements or inter-frequency measurements.

9. A processor of a user equipment (UE) configured to perform operations comprising:
receiving a configuration from a base station of a network for operations on frequency range FR2-2, the configuration including a parameter for a discontinuous reception (DRX) cycle duration and a parameter indicating an upper limit for an evaluation period for performing cell measurement and evaluation; and
performing the cell measurement and evaluation for at least the evaluation period while in a radio resource control (RRC) idle state.

10. The processor of claim 9, wherein the cell comprises a serving cell, and
when a cell selection criterion S is not satisfied for an entirety of the evaluation period, performing neighbor cell measurement and evaluation to find a suitable cell.

11. The processor of claim 9, wherein the operations further comprise:
determining, from the configuration, a value of a beam sweeping scaling factor to use for the operations on FR2-2 based on the DRX cycle and the upper limit for the evaluation period; and
using the determined scaling factor value for other RRC idle operations.

12. The processor of claim 9, wherein the UE comprises eight antenna elements per panel for performing the operations on FR2-2.

13. The processor of claim 9, wherein the operations further comprise:
reporting a capability to the network for receiving the configuration for the upper limit for the evaluation period for performing serving cell measurement and evaluation for FR2-2.

14. The processor of claim 9, wherein the cell comprises a neighbor cell and the cell measurement and evaluation is intra-frequency measurements or inter-frequency measurements.

15. A processor of a base station configured to perform operations comprising:
transmitting a configuration to a user equipment (UE) for operations on frequency range FR2-2, the configuration including a parameter for a discontinuous reception (DRX) cycle duration and a parameter indicating an upper limit for an evaluation period for performing cell measurement and evaluation; and
transmitting reference signals (RS) for measurement and evaluation by the UE in accordance with the configuration for the UE.

16. The processor of claim 15, wherein the UE comprises eight antenna elements per panel for performing the operations on FR2-2.

17. The processor of claim 15, wherein the operations further comprise:
receiving a capability report from the UE for receiving the configuration for the upper limit for the evaluation period for performing serving cell measurement and evaluation for FR2-2.

18. The processor of claim 15, wherein the cell comprises a serving cell.

19. The processor of claim 15, wherein the cell comprises a neighbor cell and the cell measurement and evaluation is intra-frequency measurements or inter-frequency measurements.
